(19) United States
(12) Patent Application Publication
(10) Pub. No.: US 2002/0004393 A1
(43) Pub. Date: Jan. 10, 2002

(54) Out-of-band signaling for aeronautical data communications networks using VHF data link mode 4

(76) Inventors: Stephen B. Heppe, Purcellville, VA (US); K. Prasad Nair, Bethesda, MD (US); Steven Friedman, Silver Spring, MD (US)

Correspondence Address: BLANK ROME COMISKY & MCCAULEY LLP, THE FARRAGUT BUILDING SUITE 1000, 900 17TH STREET NW, WASHINGTON, DC, 20006, US

(21) Appl. No.: 09/848,536

(22) Filed: May 4, 2001

Related U.S. Application Data
(60) Provisional application No. 60/203,918, filed on May 12, 2000.

(51) Int. Cl. H04Q 7/20

(52) U.S. Cl. 455/431; 455/432

(57) ABSTRACT

The present invention uses a VDL/4 RF network to support out-of-band signaling for a separate RF network.

### REFERENCE TO RELATED APPLICATION

The present application claims the benefit of U.S. Provisional Application No. 60/203,918, filed May 12, 2000, whose disclosure is hereby incorporated by reference in its entirety into the present disclosure.

### FIELD OF THE INVENTION

The present invention is directed to the economical provision of data networking services to aircraft.

### BACKGROUND OF THE INVENTION

At present it is difficult and costly for airline passengers in commercial aircraft to access modern data communications networks. While a data call can sometimes be configured from a personal computer through an air/ground telephone, the data rate is low, link reliability is low, and line charges are high. Several commercial companies have recently announced plans to deliver higher-quality, higher-speed services at lower cost.

Airlines themselves have poor access to modem data communications networks, with current air/ground data networking for Airline Operational Control (AOC) handled via 2.4 kbps modems within the ACARS family of protocols. The ACARS air/ground environment is described in ARINC Specification 618. The capabilities of onboard equipment are defined in ARINC Characteristics 597, 724 and 724B. Other standards may also apply. ACARS uses a p-persistent carrier-sense multiple-access scheme for packet data communications. Upgrades to ACARS are planned, which will increase the burst data rate but leave the access scheme essentially unchanged.

The International Civil Aviation Organization (ICAO) has recently recommended the adoption of standards for a new VHF Data Link Mode 4 (VDL/4). VDL/4 operates at 19.2 kbps and uses a self-organizing time-division multiple-access scheme for packet data communications. Part of the channel management scheme for VDL/4 relies on aircraft position information. Another part relies on accurate time known to all participating stations. A modification of the p-persistent algorithm used by ACARS is also included for some transmissions. VDL/4 has the potential to support several user applications including automatic dependent surveillance—broadcast (ADS-B) and air/ground networking.

Management and control information for a telecommunications network frequently consumes valuable bandwidth and data carrying capacity, which correspondingly reduces the quantity of user information that can be transferred in a specified period of time. If two communication networks A and B were available, with differing costs and performance, management and control information could be carried on one network A and user information could be carried on the other network B in order to enhance overall performance and cost-effectiveness. In terrestrial networks such as the public switched telephone network, a shift to out-of-band signaling, wherein call setup and other system configuration information is exchanged via communications resources separate from the resources used for customer data communications, has enabled more efficient communications and also enhanced security.

Out-of-band signaling is not commonly applied in aeronautical RF networks. In aeronautical RF networks where call setup and other system configuration information is segregated from customer data communications by e.g. frequency, time or code division multiplex, out-of-band signaling may be considered to exist in a logical sense, but a common RF resource is nevertheless consumed to a greater or lesser degree.

### SUMMARY OF THE INVENTION

The present invention uses a VDL/4 RF network to support out-of-band signaling for a separate RF network.

### BRIEF DESCRIPTION OF DRAWINGS

FIG. 1 illustrates an aircraft operating in a VDL/4 network A as well as another RF communications network B, wherein management and control information for network B is exchanged through the VDL/4 network A.

### DETAILED DESCRIPTION OF THE INVENTION

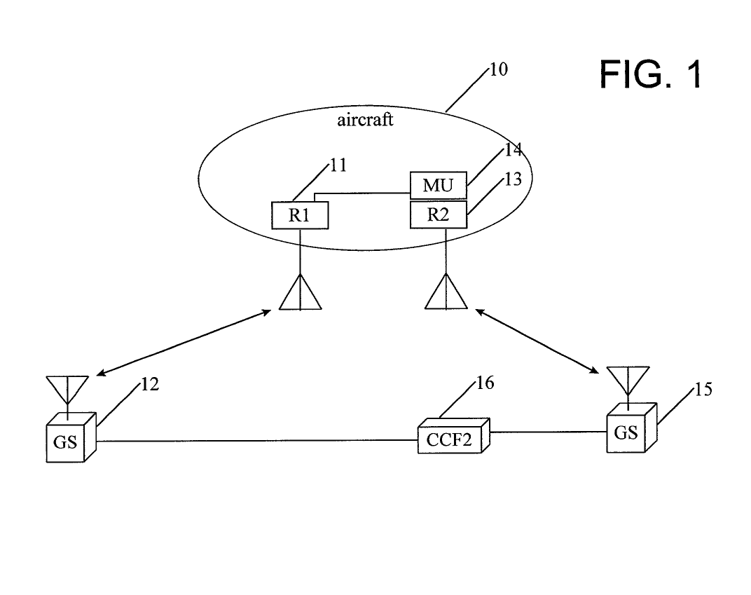

FIG. 1 illustrates an aircraft 10 operating in a VDL/4 network A comprising radio Rl 11 installed on the aircraft and ground station 12, as well as another RF communications network B comprising radio R2 13 with associated management unit 14 installed on the aircraft, ground station 15, and communications control facility 16. Management and control information for network B is exchanged through the VDL/4 network A, appropriate interwiring means between radio RI and the airborne management unit 14, and appropriate interwiring means or internetworking means between ground station 12 operating in the VDL/4 network and CCF2 16 operating as an element of communications network B. Management unit 14 and CCF2 16 perform management and control tasks for communications network B including e.g. hardware configuration control, handoff between ground stations, frequency tuning and channel access. Management and control information for communications network B, exchanged through the VDL/4 network A, is treated as user data in VDL/4 network A and routed to/from the airborne management unit 14 and ground-based CCF2 16 using e.g. a standard internetworking protocol such as IPv6 or the ATN.

Management and control information for communications network B may also be exchanged within communications network B as an adjunct to the exchange of management and control information through VDL/4 network A, either as an alternative route or for the exchange of different classes of management and control information.

While preferred embodiments of the present invention have been set forth above, those skilled in the art who have reviewed the present disclosure will readily appreciate that other embodiments can be realized within the scope of the invention. For example, protocols other than those disclosed can be used. Therefore, the present invention should be construed as limited only by the appended claims.

We claim:

1. A communication method comprising:
establishing communication between two locations over an aeronautical RF network; and
out-of-band signaling between the two locations over a VDL Mode 4 subnetwork or network for management and control information exchange.

2. The communication method of claim 1, wherein the management and control information exchanged via the VDL Mode 4 subnetwork or network is treated as Airline Operational Control information, or Airline Administrative Control information contributing to the safety and regularity of flight.
